(19) United States
(12) Patent Application Publication
(10) Pub. No.: US 2014/0019706 A1
(43) Pub. Date: Jan. 16, 2014

(54) SYSTEM AND METHOD OF LOGICAL OBJECT MANAGEMENT

(71) Applicant: Arnon Kanfi, Tel Aviv (IL)

(72) Inventor: Arnon Kanfi, Tel Aviv (IL)

(73) Assignee: INFINIDAT LTD., Herzliya (IL)

(21) Appl. No.: 13/549,586

(22) Filed: Jul. 16, 2012

(51) Int. Cl. G06F 12/02

(52) U.S. Cl. 711/171; 711/E12.002

(57) ABSTRACT

A virtual allocation unit is allocated in a virtual address space corresponding to a filesystem, in response to an allocation requirement, related to a logical object in the filesystem. The size of the virtual allocation unit is determined in accordance with the current physical size of the logical object. The size of the virtual allocation unit is substantially larger than a size required with respect to the allocation requirement. Physical block address ranges are allocated in a physical storage space, in response to subsequent write requests, related to the logical object. Each physical block address range is associated with a respective portion of the virtual allocation unit.

### TECHNICAL FIELD

The presently disclosed subject matter relates to the field of storage space allocation for objects of a file system.

### BACKGROUND

A filesystem is a means for managing logical objects and organizing data that is stored in a storage device, as a collection of logical objects, such as files, directories, hard links, soft links, access control lists (ACLs) and the like. The filesystem may be part of an operating system or an add-on program capable of managing the organization of logical objects on a storage media and allocating respective storage space. In order to present the data as a collection of logical objects, the filesystem maintains structures of metadata. The term “metadata” as used herein in a context of a filesystem should be expansively construed to cover any kind of descriptive data related to the logical objects that does not constitute a part of the logical object's content. The descriptive data may include information that describes volumes, files, directories, or any other logical objects. For example, the following descriptive data describe a file and are considered as part of the file's metadata: a file name, file size, creation time, last access/write time and block pointers that point to the actual data of the file on a storage device.

The filesystem is further responsible for allocating storage space required to store files data and for keeping track of which blocks of the storage device belong to which file and which blocks are not being used. File systems allocate storage space in a granularity of physical blocks that compose the underlying storage device. A physical block is the smallest unit writable by a disk. A file system block (the basic allocation quantum used by the filesystem) is at least the same size as or larger (in integer multiples) than the physical block size.

Filesystem allocation schemes determine the size of additional storage space to be allocated for new data of a file, so as to satisfy the size required to store the new data. Fixed sized allocation units (blocks) are used, such that in each allocation request a block or multiple blocks are allocated.

The filesystem is associated with a volume that has been initialized for hosting the filesystem. The volume is a collection of blocks on one or more storage devices (e.g. disks). The volume may be all of the blocks on a single storage device, the blocks of a partition, which is a portion of the storage device, or it may even span over multiple storage devices.

The files' metadata is generally stored in a dedicated area of the same volume that stores files and directories of the filesystem.

As mentioned above, filesystems stores for each file, as part of the file's metadata, references to data blocks that point to the file's data on the volume. Space allocation and reference to allocated space in the file's metadata is implemented by using one of the following techniques:

(i) Block based allocation—uses fixed size blocks for storing and pointing to file data; and

(ii) Extent based allocation—stores the data in variable length extents. An extent includes a range of blocks, expressed by a reference to a starting block and a length that indicates the number of successive blocks following the starting block.

An Mode (index node) is a structure that contains metadata of one file, including a mapping of the file's data, expressed by either block pointers or extent pointers.

When using the block based allocation scheme, the Mode contains, among other metadata parameters, a list of block references (pointers), one block reference for each of the blocks of the file, which are used to store the data of the file. Generally, only a limited number of block references are directly stored in the Mode, which therefore limits the amount of data the file can contain.

When an object, particularly a file, is created in the system, an Mode is allocated for holding the file metadata including the block pointers. Usually, an Mode must fit into a single block, imposing an apparent upper limit on file size. Consider a system with 512B blocks (this block size applies to both data blocks and metadata blocks). If each block pointer within the Mode is 4B large, and each Mode consists solely of block pointers, then a file can be no larger than (512B/4B)*512B=65536B=64K. Hence, modern UNIX systems use a hierarchical Mode structure, where the Mode contains pointers to data blocks and blocks of pointers (the so-called indirect blocks). On Linux, for example, the first 12 pointers, of the Mode, directly point to data blocks. This works just fine for small files. If more space is needed, then pointer 13 points to a block that contains references to more data blocks (the indirect block). If even more space is needed, then pointer 14 points to a block that contains pointers to indirect blocks (the doubly-indirect block). If even more space is needed, then pointer 15 points to a block that contains pointers to doubly indirect blocks (the triply-indirect block). Using this scheme, small files (files that fit into 12 or fewer blocks) use only one block (the Mode block) for indexing, but large files can be accommodated as well. For example a file of 30 block size and 4B per block pointer occupies 12*512B=6144B for the direct blocks, (512/4)*512B=64K for the indirect block and (512/4)*64K=8 MB for the doubly-indirect blocks and last, (512/4)*8 MB=1 GB for the triply-indirect block.

Block based allocation is simple and easy to implement. The drawback is the need to read more than one block of metadata in order to access the file's data that is indirectly referenced. Reading/writing multiple indirect blocks or extents tree-nodes in addition to file's data upon read/write requests slows down access. Examples of filesystems that use block allocations include UFS, Ext2/3, ZFS, FAT and more.

Extent based allocation uses more compact descriptors and requires fewer levels of indirection. Because of the fact that extents have variable lengths, the extents are usually stored in some kind of a B-tree, which adds some complexity. Examples of filesystems that use extent based allocation include NTFS, XFS, Ext4, VXFS and more.

By way of non-limiting example, allocating the volumes can be provided using a technique of thick provisional or technique of thin provisional. Thick volume provisioning is a traditional volume provisioning of allocating all the physical blocks up front. Thin volume provisioning is a technique using virtualization technology to give the appearance of more physical storage space than is actually allocated. The space allocated to the thin volume, upon volume creation, is a virtual space rather than a physical storage space. Ranges of the physical storage space are allocated, only upon writing actual data. Mapping techniques are used for mapping ranges of virtual address space into ranges of allocated physical storage space.

### SUMMARY

According to certain aspects of the presently disclosed subject matter there is provided a method of allocating space for logical objects of a filesystem, utilizing a processor, operatively coupled to one or more physical storage devices constituting a physical storage space. The method includes: (a) responsive to an allocation requirement related to a logical object in the filesystem, allocating, by the processor, in a virtual address space corresponding to the filesystem, a virtual allocation unit, comprising a range of contiguous virtual block addresses; wherein a size of the virtual allocation unit is determined in accordance with a current physical size of the logical object; and wherein the size of the virtual allocation unit is substantially larger than a size required with respect to the allocation requirement; and (b) responsive to subsequent write requests, related to the logical object, enabling allocating, per each of the write requests, a physical block address range in the physical storage space and enabling associating the physical block address range with a respective portion of the virtual allocation unit.

In accordance with further aspects and, optionally, in combination with other aspects of the presently disclosed subject matter, the method can further include assigning to the filesystem the virtual address space and a maximum physical space size available for use by the filesystem in the physical storage space, wherein a size of the virtual address space is substantially larger than the maximum physical space size.

In accordance with certain aspects of the presently disclosed subject matter, the virtual address space can be associated with a logical volume assigned for the filesystem.

The method can further include associating the virtual allocation unit with an offset within an address range of the logical object.

In accordance with further aspects of the presently disclosed subject matter, the method can further include determining the size of the virtual allocation unit by comparing the current physical size of the logical object to multiple size thresholds and selecting the size of the virtual allocation unit from multiple allocation unit sizes respectively associated with the multiple size thresholds.

In accordance with certain aspects of the presently disclosed subject matter, the values of the multiple allocation unit sizes can respectively depend on the multiple size thresholds and represent a growth sequence.

In accordance with further aspects of the presently disclosed subject matter, the method can further include, upon initialization of the filesystem, logically dividing the virtual address space into multiple allocation zones, respectively associated with multiple allocation unit sizes; wherein each allocation zone includes a plurality of virtual allocation units of equal size, the equal size being one of the multiple allocation unit sizes.

In accordance with further aspects of the presently disclosed subject matter, the step of allocating a virtual allocation unit can include selecting a specific allocation zone from the multiple allocation zones, in accordance with the current physical size of the logical object and allocating the virtual allocation unit from the plurality of virtual allocation units of the specific allocation zone.

According to the other aspects of the presently disclosed subject matter there is provided a system for managing logical objects. The system includes a processor operatively coupled to a memory accessible by the processor, wherein the system is operatively coupled to at least one storage device constituting a physical storage space, wherein the memory is configured to handle a virtual address space that includes virtual block addresses, and wherein the processor is configured to: (i) responsive to an allocation requirement, related to a logical object in a filesystem, allocate, in a virtual address space corresponding to the filesystem, a virtual allocation unit that includes a range of contiguous virtual block addresses; wherein a size of the virtual allocation unit is determined in accordance with a current physical size of the logical object; and wherein the size of the virtual allocation unit is substantially larger than a size required with respect to the allocation requirement; and (ii) responsive to subsequent write requests, related to the logical object, enable allocation, per each of the write requests, a physical block address range in the physical storage space and enable association of the physical block addresses with a respective portion of the virtual allocation unit.

According to the other aspects of the presently disclosed subject matter there is provided a storage system for managing logical objects. The storage system comprising an object management system and a block management system, wherein the storage system is coupled to at least one storage device constituting a physical storage space; wherein, responsive to an allocation requirement related to a logical object of a filesystem, the object management system is configured to allocate, in a virtual address space corresponding to the filesystem, a virtual allocation unit, comprising a range of contiguous virtual block addresses; wherein a size of the virtual allocation unit is determined in accordance with a current physical size of the logical object; and wherein the size of the virtual allocation unit is substantially larger than a size required with respect to the allocation requirement; and wherein, responsive to subsequent write requests related to the logical object, the block management system is configured to allocate, per each of the subsequent write requests, a physical block address range in the physical storage space and associate the physical block addresses with a respective portion of the virtual allocation unit

Among advantages of certain embodiments of the presently disclosed subject matter is reducing the fragmentation of a virtual address space allocated to a filesystem, so as to reduce the amount of entries in a mapping data structure, associated with the virtual address space. Among further advantages of certain embodiments of the presently disclosed subject matter is reducing the number of blocks/extents of a file to a small set of block extents, even for very large files, so that the whole block mapping may fit in the metadata entry of the file and thus speeding up I/O and access to metadata by eliminating indirect extent blocks access for large files.

### BRIEF DESCRIPTION OF THE DRAWINGS

In order to understand the presently disclosed subject matter and to see how it may be carried out in practice, the subject matter will now be described, by way of non-limiting examples only, with reference to the accompanying drawings, in which:

FIGS. 1a and 1b illustrate a functional block diagram of a system capable of managing logical objects in accordance with certain embodiments of the currently presented subject matter;

FIG. 1c illustrates a logical functional diagram of a system capable of managing logical objects in accordance with certain embodiments of the currently presented subject matter;

FIG. 2 illustrates a schematic diagram of a logical address space divided into multiple allocation zones, in accordance with an embodiment of the presently disclosed subject matter;

FIG. 3 illustrates an example of a translation table that is utilized for selecting an allocation zone to serve a file of a given size, in accordance with an embodiment of the presently disclosed subject matter;

FIGS. 4a-4c illustrate virtual and physical allocation for a file, in accordance with an embodiment of the presently disclosed subject matter;

FIGS. 5 and 5a are flowcharts illustrating a method for allocating space, in accordance with an embodiment of the presently disclosed subject matter; and

FIG. 6 illustrates an example of an extent list that is part of a metadata entry, in accordance with an embodiment of the presently disclosed subject matter.

### DETAILED DESCRIPTION

In the drawings and descriptions set forth, identical reference numerals indicate those components that are common to different embodiments or configurations.

Unless specifically stated otherwise, as apparent from the following discussions, it is appreciated that throughout the specification discussions utilizing terms such as “allocating”, “determining”, “enabling”, “assigning”, “associating”, dividing”, “selecting” or the like, refer to the action and/or processes of a computer that manipulate and/or transform data into other data, said data represented as physical quantities, e.g. such as electronic quantities, and/or said data representing the physical objects. The term “computer” as used herein should be expansively construed to cover any kind of electronic device with data processing capabilities.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus the appearance of the phrase “one case”, “some cases”, “other cases” or variants thereof does not necessarily refer to the same embodiment(s).

It is appreciated that certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

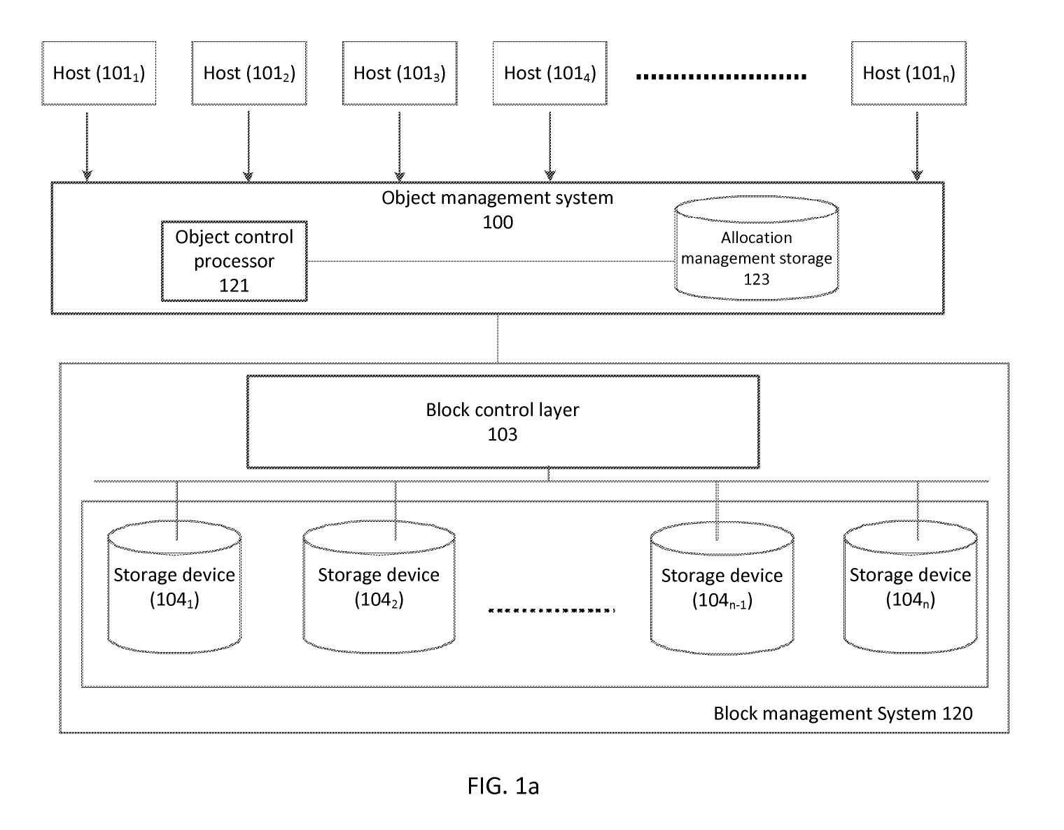

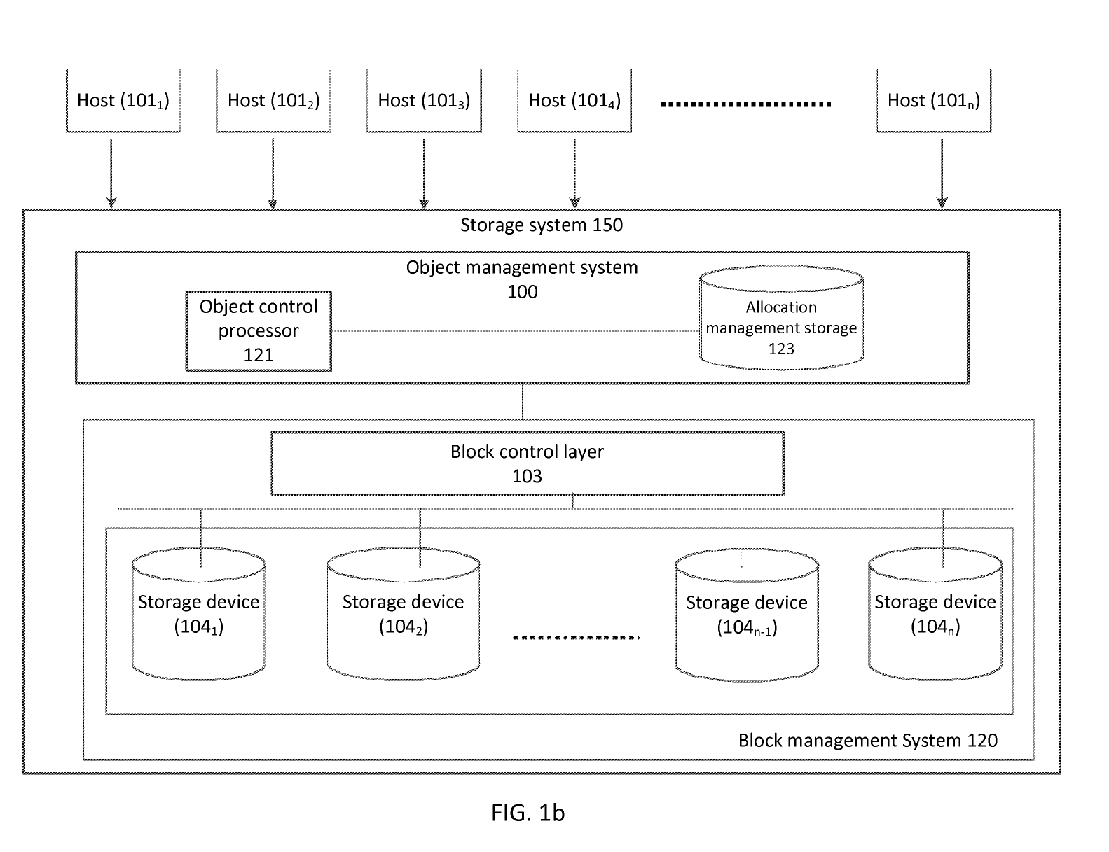

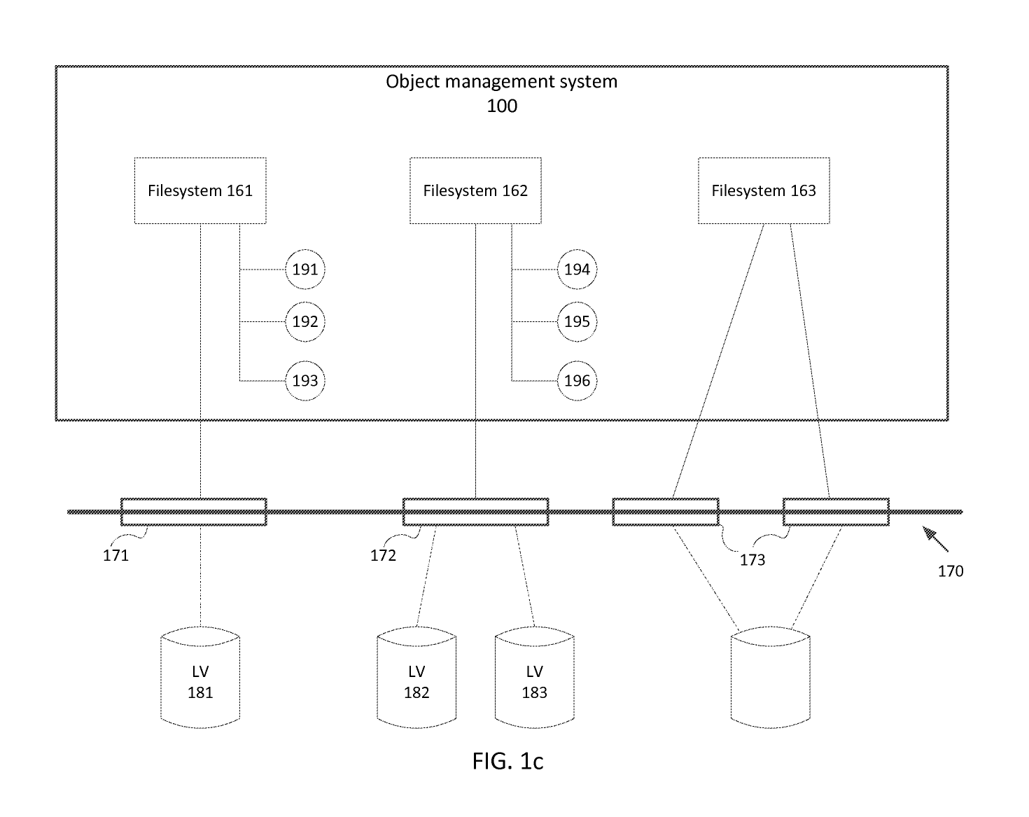

FIGS. 1a and 1b illustrate a schematic block diagram of an object management system 100 for managing at least one filesystem and the logical objects thereof and more particularly, for managing memory allocation for the logical objects, according to embodiments of the presently disclosed subject matter.

Object management system 100 implements one or more filesystems (e.g. NFS, CIFS and the like) or of an OSD (Object Storage Device) interface and enables external applications or hosts, such as hosts 101₁₋ₙ, to access objects, e.g. files, that are stored in storage devices 104₁₋ₙ. Hosts 101₁₋ₙ interface object management system 100, using a client side filesystem application or any other file access interface.

Object management system 100 is responsible for managing the objects' metadata of one or more filesystems. Each filesystem, supported by object management system 100, utilizes a metadata table, such as an Mode table. The Mode table stores for each object (e.g. a file) an Mode (a metadata record) including all the metadata of a file, and particularly: pointers to allocation units or extents of allocation units that holds the entire object's data. Object management system 100 is further configured to allocate allocation units for storing files' data, upon demand, according to embodiments of the presently disclosed subject matter.

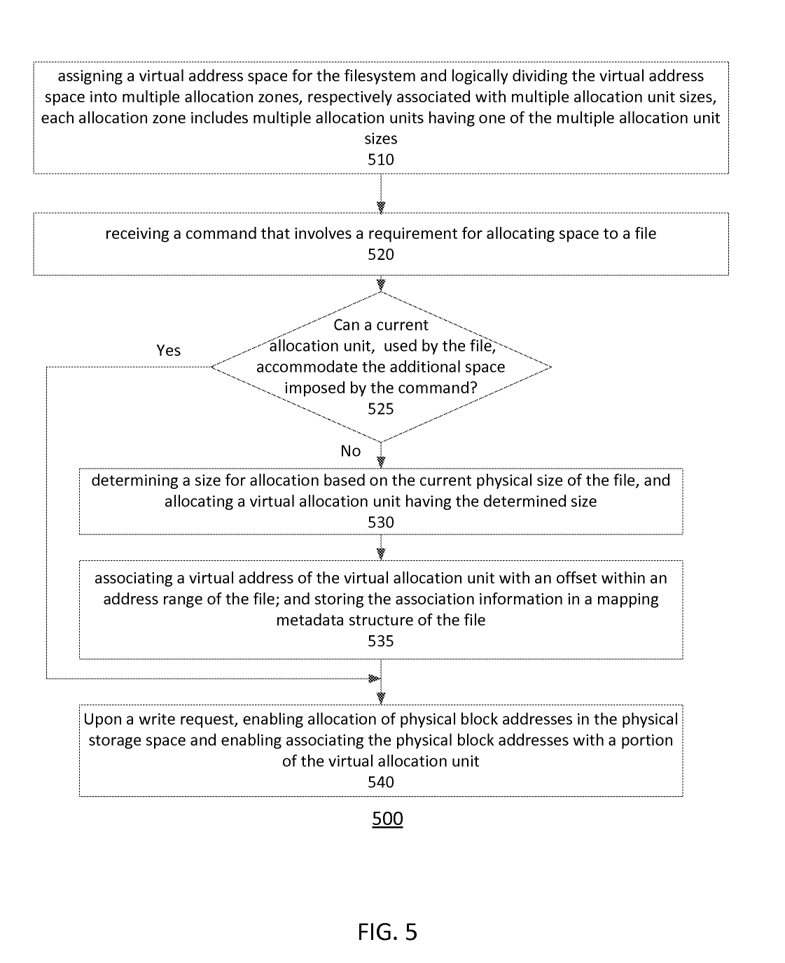

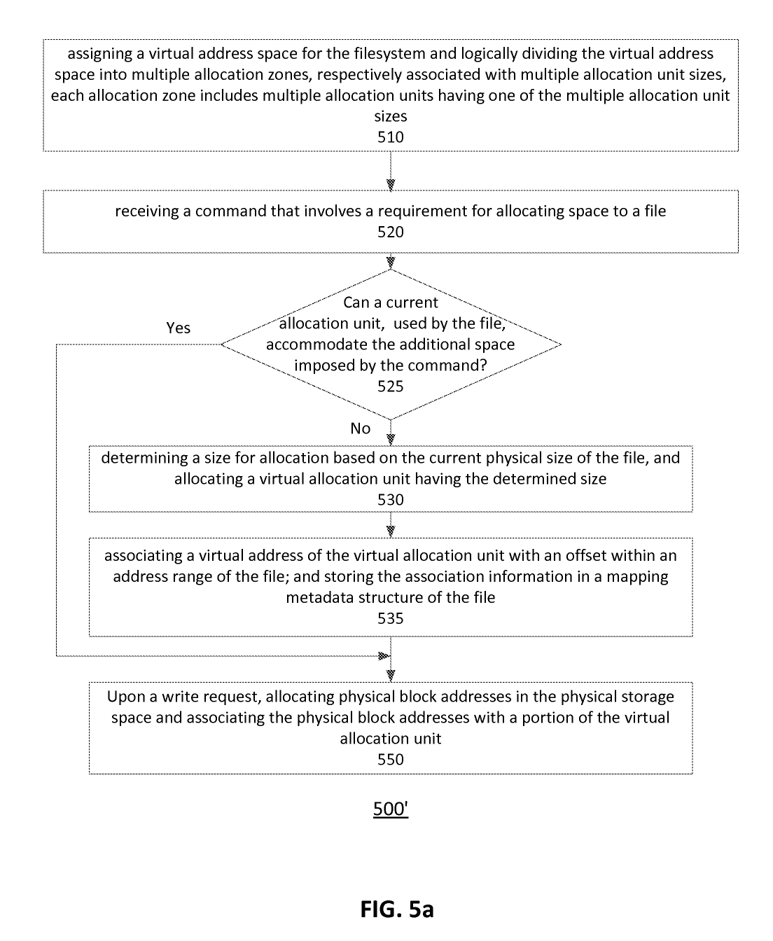

Object management system 100 may include or be otherwise associated with at least one processing unit, such as object control processor 121, configured to control and execute commands, such as filesystem commands which are issued by other applications or hosts 101₁₋ₙ and more specifically commands that are related to extent allocation for a file. Such commands may include for example: a write request that causes augmentation of a file size or an explicit command to increase a size of a file, e.g. SetAttributes command of NFS (Network FileSystem). Object control processor 121 is further configured to operate as further detailed with reference to FIG. 5.

FIG. 1a illustrates object management system 100 that is operatively coupled to a block management system 120 that includes a block control layer 103 and one or more storage devices 104₁₋ₙ. Object management system 100 benefits block access services provided by block control layer 103. By way of non-limiting example, block control layer can enable thin volume provisioning or other allocation techniques for implementing extent allocation according to embodiments of the presently disclosed subject matter.

Block control layer 103 is coupled to a plurality of data storage devices 104₁₋ₙ constituting a physical storage space. Block control layer 103 includes one or more processors that are operable to handle a virtual representation of the physical storage space and to facilitate mapping between the physical storage space and its virtual representation. In such cases, block control layer 103 can be configured to create and manage at least one virtualization layer interfacing between object management system 100 (or other external applications and hosts) and the physical storage space. The virtualization functions may be provided in hardware, software, firmware or any suitable combination thereof.

Object management system 100 interfaces with hosts 101 using an object representation. The object interface used to communicate with hosts 101 includes, for example: a filesystem (or volume) identifier, a file identifier (e.g. Mode number, filename and path) and an offset within the file (e.g. a byte offset or block offset within the file). On the other side, object management system 100 interfaces with block control layer 103 using a block virtual representation. The interface between object management system 100 and block control layer 103 includes, for example: a volume identifier and a block offset within the volume.

The physical storage space may comprise any appropriate permanent storage medium and may include, by way of non-limiting example, one or more disk units (DUs), also called “disk enclosures”, including several disk drives (disks).

The physical storage space further includes a plurality of physical data blocks, each physical data block may be characterized by a pair (DD_{id}, DBA) where DD_{id} is a serial number associated with the disk drive accommodating the physical data block, and DBA is a block number within the respective disk.

The entire address space of the storage system is divided into logical volumes, and each logical volume becomes an addressable device. A logical volume (LV) or logical unit (LU) represents a plurality of data blocks characterized by successive Logical Block Addresses (LBA). Different logical volumes may comprise different numbers of data blocks, which are typically of equal size within a given system (e.g. 512 bytes).

A logical volume is used by object management system 100 for hosting a filesystem. The logical volume stores all the filesystem objects' data and further includes a dedicated area or file for storing the Mode table of the filesystem.

FIG. 1b illustrates a storage system 150 that includes both object management system 100 and block management system 120. The content, capabilities and functions of object management system 100 and block management system 120 within storage system 150 is the same as described for FIG. 1a.

FIGS. 1a and 1b, described above, illustrates a general schematic diagram of the system architecture in accordance with an embodiment of the presently disclosed subject matter. Certain embodiments of the present invention are applicable to the architecture of a computer system described with reference to FIG. 1a and FIG. 1b. However, the invention is not bound by the specific architecture; equivalent and/or modified functionality may be consolidated or divided in another manner. Those versed in the art will readily appreciate that the teachings of the presently disclosed subject matter are, likewise, applicable to any computer system and any storage architecture implementing a virtualized storage system. In different embodiments of the invention the functional blocks and/or parts thereof may be placed in a single or in multiple geographical locations (including duplication for high-availability); Operative connections between the blocks and/or within the blocks may be implemented directly (e.g. via a bus) or indirectly, including remote connection. Connections between different components in illustrated in FIG. 1, may be provided via Wire-line, Wireless, cable, Internet, Intranet, power, satellite or other networks and/or using any appropriate communication standard, system and/or protocol and variants or evolutions thereof (as, by way of unlimited example, Ethernet, iSCSI, Fiber Channel, etc.).

FIG. 1c is a logical functional diagram of object management system 100 that illustrates the relation between filesystems, logical objects and virtual address space allocated for accommodating the logical objects of each filesystem. Object management system 100 includes one or more filesystems, such as filesystems 161, 162 and 163. Each filesystem is assigned with a virtual address space, which may be part of or all of a global virtual address space 170. Global virtual address space 170 may be managed by another entity, such as block management system 120. The assignment of virtual address space to a filesystem is generally assigned upon an initialization of the filesystem. The virtual address space assigned to a filesystem may be a contiguous virtual address range within global virtual address space 170, such as virtual address space 171 and 172, or may be composed of more than one virtual address range, such as virtual address space 173. The virtual address space may be defined as a logical volume (LV) that is assigned for the filesystem, for example, virtual address space 171 is defined as a logical volume 181 that is assigned for filesystem 161. Alternatively, the virtual address space may be spanned over more than one logical volume, such as virtual address space 172 that is spanned over logical volumes 182 and 183. The virtual address space may otherwise be defined as a sub-volume or a partition within a logical volume.

Each filesystem owns multiple logical objects, for example: filesystem 161 owns logical objects 191, 192 and 193 that are stored in virtual address space 171 (or logical volume 181), while filesystem 162 owns logical objects 194, 195 and 196 that are stored in virtual address space 172. The logical objects as referred to hereinafter are objects that require space allocation for storing data thereof. Such logical objects are typically files, but other objects may also require space allocation for data, for example, ACLs (access control list). In the following description, the term ‘file’ may be used as an example for a logical object that requires space allocation. It should be noted that the term file can be replaced with the term ‘logical object’, referring to an object that requires space allocation.

Object control processor 121 is configured to implement extent allocation so that the amount of additional virtual space allocated to new data of a file, upon each allocation request, depends on the current file size rather than the size indicated in the allocation request. As the file grows, the size of the virtual space allocated for new data, grows. Such allocation is referred to hereinafter also as progressive extent size allocation.

When a small file needs additional storage space, virtual allocation units of a basic size are allocated to fulfill the allocation request. For example: if the file size is smaller than e.g. 2 MB, virtual allocation units having a size of e.g. 64 KB are allocated, upon demand. When a file access operation (e.g. a write operation) triggers additional space allocation, the current physical size of the file is evaluated by comparing the current physical file size to multiple size-thresholds. If the file size traverses one of the size thresholds, a virtual allocation unit of a bigger size is allocated. For example: if the file has just traversed the 2 MB threshold, virtual allocation units of e.g. 1 MB will be allocated upon subsequent allocation requests, until the file size exceeds a higher size-threshold (e.g. 6 MB size threshold). At any stage, the size of the allocated units depends on the current size of the file. The growth of allocated unit sizes, upon each size threshold traversal, may be according to a growth function, such as: an exponential growth, factor growth, linear growth or any other growth function or any other predetermined growth definition. Values of the multiple allocation unit sizes respectively depend on the multiple size thresholds and represent a growth sequence, which may be a progressive growth sequence (i.e. more rapid than a linear trend). For example: suppose there are 4 size thresholds: 1M, 2M, 6M and 64M. The sizes of allocation units allocated for files having a size below these thresholds, may be chosen as, e.g.: 64K, 500K, 2M and 32M, respectively.

Certain embodiments of the presently disclosed subject matter, utilize virtual allocation units of various sizes, such that the size variation among the different allocation units can be of many orders of magnitude. For example: the different between sizes of allocation units belonging to two consecutive classes can be a factor of e.g. 16 (example: a first size is 64 KB and a second size is 1 MB), so that the difference between the sizes of allocation units of the first class and sizes of allocation units of the third class is 16×16=256, the difference between the sizes of the first class and the forth class is 16×16×16=4096, etc. Note, that the difference between sizes of allocation units of consecutive classes can be other than a factor of 16 and the factor can be smaller when dealing with smaller allocation units and can grow as the size of allocation units grows.

The following allocation mechanism is adapted, so as to facilitate the allocation process of allocation units having a large size variance.

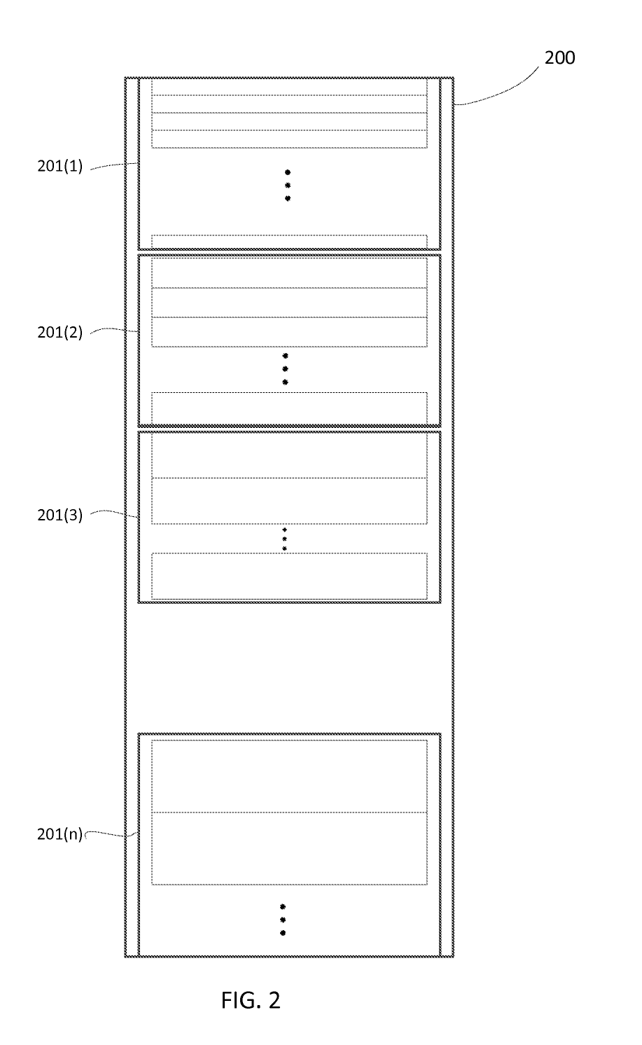

FIG. 2 illustrates a virtual address space corresponding to a filesystem, e.g. logical volume 200 that is divided into n virtual allocation zones 201(1)-201(n) for storing data of filesystem objects, according to an embodiment of the presently disclosed subject matter. Each virtual allocation zone 201 includes virtual allocation units having a certain size that is different from sizes of allocation units in any other allocation zone. Each virtual allocation zone 201 is used for allocating units to files of different sizes corresponding to allocation units configured in the respective zone. For example: the virtual allocation units included in virtual allocation zone 201(1) may have a size of 64 KB and are allocated to small sized files that are smaller than e.g. 2 MB. The virtual allocation units included in virtual allocation zone 201(2) may have a size of 1 MB and are allocated to files having a size of, e.g. 2 MB to 8 MB, and virtual allocation zone 201(n) that serves huge files may include virtual allocation units having a size of e.g. hundreds of Giga bytes or even Tera bytes or more. Logical volume 200 may include other zones, not shown in FIG. 2, for example, a special zone for storing metadata of the filesystem objects.

Referring back to FIG. 1, object control processor 121 is further configured, upon an allocation request, to select an allocation zone that stores allocation units of the required size. Object management system 100 may include a local storage device coupled to object control processor 121, such as an allocation management storage 123 that stores information related to the allocation zones, e.g. a virtual start address and a size of each allocation zone, free space management of each allocation zoned, etc.

Logical volume 200 that implements the progressive extent size allocation, is preferably a thin provisioned volume and thus can benefit the following features provided by a thin volume provisioning: (i) logical volume 200 is mapped within a virtual address space, provided by one of the virtualization layers of the system, and can have a substantial large size, so that it can accommodate virtual allocation units of almost unlimited size. The size of logical volume 200 may be significantly larger than the physical size utilized or allowed for use by the filesystem associated with the volume; (ii) allocating physical storage ranges for actual data only upon demand (actual writing of data); and (iii) accessing high addresses of logical volume 200 for writing to allocation zones that reside, all over volume 200 and without needing to physically allocate the unused space between allocation zones or within allocation zones. Though volume 200 preferably utilizes thin volume provisioning, volume 200 may otherwise utilize any other volume provisioning.

Volume management employs data structures for mapping virtual address blocks (such as virtual allocation units within volume 200, as presented to object management system 100) into physical address blocks. An efficient implementation of a mapping data structure utilizes a sparse data structure that may be implemented using one mapping entry per each contiguous virtual address range. The mapping entry of the contiguous virtual address range also includes an associated physical address range, if allocated. If no physical address range is allocated for the corresponding virtual address range, then the mapping entry points to null, or otherwise, the entry does not exists. Thus, a highly fragmented logical volume requires a mapping data structure having a large number of entries, one per each contiguous virtual address range (fragment) that consume a substantial amount of memory. Thus, it is advantageous to reduce the fragmentation of the virtual volume so as to reduce the amount of entries in the mapping data structure, associated with the logical volume. Allocating a virtual allocation unit, as disclosed herein, enables a reservation of a contiguous virtual address range, for future use by the file related to the allocation. Physical address ranges are allocated only upon demand, i.e. upon writing real data and are associated with virtual address ranges within the virtual allocation unit.

The division of logical volume 200 into virtual allocation zones may only be known to object management system 100, while block control layer 103 may not be aware of the organization of logical volume 200 or of the extent allocation, disclosed herein. Allocation of a virtual allocation unit from one of the allocation zone is preferably managed by the object management system 100. Block control layer 103 does not allocate virtual nor physical space to accommodate the new allocation unit. Only when new data is actually written, a range of physical address space is allocated in data storage devices 104₁₋ₙ and a portion of the virtual address space, included within the allocation unit, is mapped into the range of physical address space. Note that allocating a substantial amount of virtual space provided by an allocation unit, ensures that a sequential virtual space is preserved for future writing, so that a fragmentation of the virtual address space is reduced.

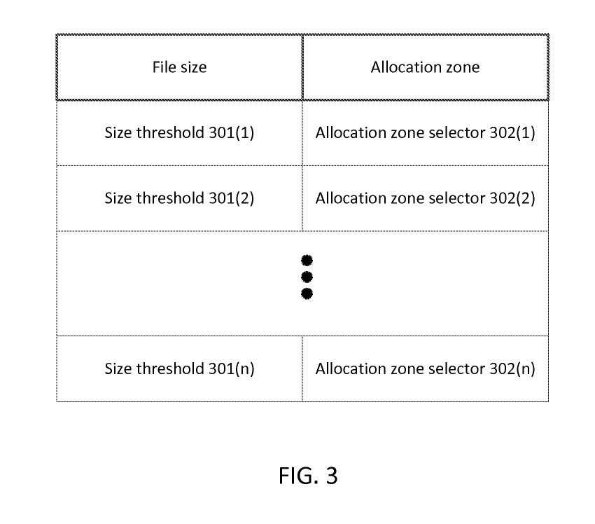

FIG. 3 illustrates a table that can be used for selecting an allocation zone for serving files of a given size, according to an embodiment of the presently disclosed subject matter. It is noted that the allocation zone selection can be implemented using other algorithms, for example, the allocation zone can be calculated, based on the file size, rather than being provided by using a table. If a size of a file is below a size threshold 301(1), then allocation zone selector 302(1) indicates that allocation zone 201(1) provides the allocation units for the next allocation for the file. If the size of the file exceeds size threshold 301(1) but is below size threshold 301(2), then allocation zone selector 302(2) indicates that allocation zone 201(2) provides the allocation units for the next allocation. Size threshold 301(n) may represent the largest files that can be supported or may be an infinite number if there is no size limit.

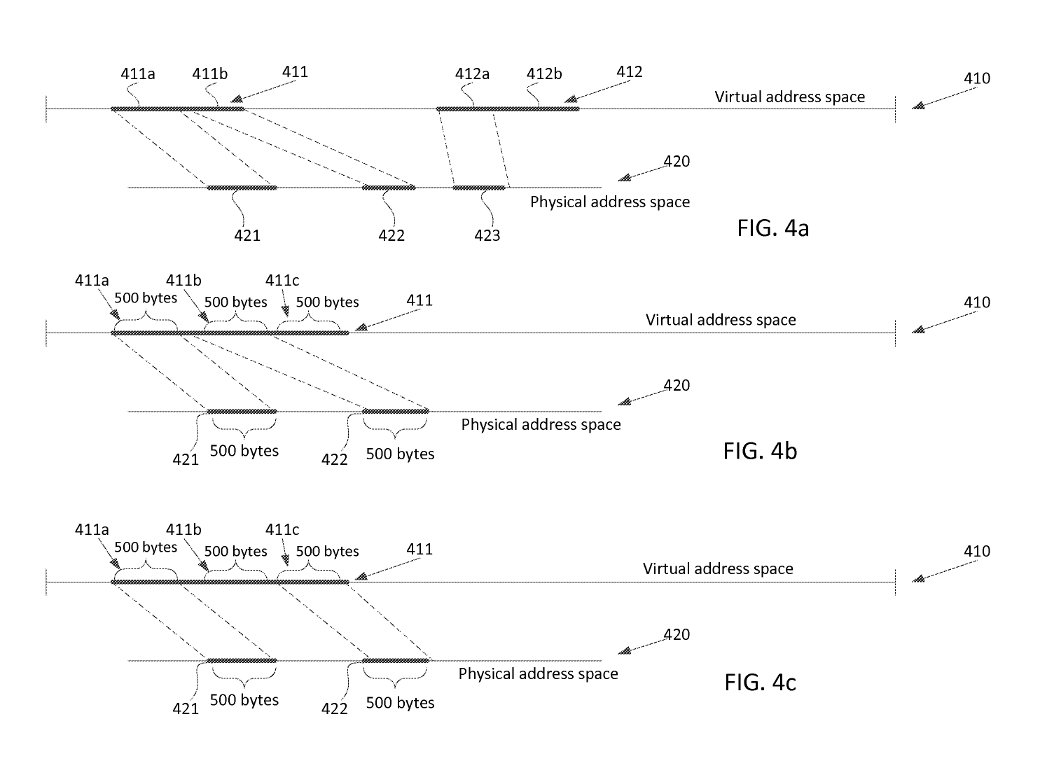

FIGS. 4a-4c demonstrate space allocation for a file. Referring to FIG. 4a, vertical line 410 represents a virtual address space 410 allocated for the filesystem, which may be logical volume 200. Vertical line 420 represents the physical storage space coupled to object management system 100 that is shared among the filesystems supported by object management system 100. Segments 421, 422 and 423 (illustrated as thick lines) represent physical ranges that are actually allocated for the file's data. Segments 411 and 412 (illustrated as thick lines) represents two virtual allocation units, 411 and 412 allocated for the file. Virtual allocation unit 411 is full, i.e. the entire address range of the allocation unit is mapped into physical ranges, in this example, a portion 411a of virtual allocation unit 411 is mapped to physical range 421 and another portion 411b is mapped into physical range 422. Virtual allocation unit 412 is partially full and is the current allocation unit that provides virtual address space for the file, for subsequent write requests. One portion 412a is mapped to physical range 423 and another portion 412b is free for use.

FIG. 4b illustrates space allocation of a file, having two physical address ranges, 421, 422, each of 500 bytes, allocated for data of the file and mapped to two successive portions (411a, 411b) of allocation unit 411. The current physical size of the file is 1000 bytes (the sum of the sizes of physical address ranges 421, 422, as well as the size of all occupied portions in allocated virtual allocation units). The available virtual space for future writings is 500 bytes, provided by portion 411c.

FIG. 4c illustrates a similar space allocation of a file, however, the virtual address space allocated for the file is non-continuous, as non-continuous portions 411a and 411c of allocation unit 411 are mapped into physical address ranges, while the middle portion 411b is not mapped. This scenario may be a result of punching a hole in the file (at offset 500 from the start of the file to offset 999). The punching causes freeing the physical address range that corresponds to portion 411b. According to an alternative scenario, the hole may be a result of writing data in a non-sequential manner, for example: at the time the file had a capacity of 500 bytes, occupying offsets 0-499, a write request was issued for writing 500 bytes at an offset 1000 from the start of the file. The non-sequential write request caused the allocation of only 500 bytes in the physical storage space, leaving a hole in the virtual allocation unit (i.e. an unmapped portion).

FIG. 5 illustrates a method 500 for allocating space for logical objects of a filesystem. The steps of method 500 can be performed by object control processor 121 of object management system 100. The term ‘logical object’ refers to an object that requires space allocation for storing data of the object, for example: a file.

Step 510 is executed upon initialization of the filesystem and includes assigning a virtual address space for the filesystem and logically dividing the virtual address space, into multiple allocation zones, respectively associated with multiple allocation unit sizes. Each allocation zone includes a plurality of virtual allocation units of equal size, the equal size being one of the multiple allocation unit sizes, i.e. there are n allocation zones and n allocation unit sizes, S₁ to Sₙ, wherein a first allocation zone includes a certain number, X₁ of virtual allocation units, each has a size of S₁, a second allocation zone includes X₂ virtual allocation units, each has a size of S₂ and a n^{th} allocation zone includes Xₙ virtual allocation units, each has a size of Sₙ. The virtual address space assigned for the filesystem may be a logical volume, multiple logical volumes, part of a logical volume or a portion of a virtual address layer used by object management system 100. Step 510 further includes assigning, for the filesystem, a maximum physical space size that defines the total amount of physical space available/allowed for use by the filesystem in the physical storage space. The size of the virtual address space is substantially larger than the maximum physical space size. The virtual address space can be larger by orders of magnitude than the maximum physical space size and at least ten times larger than the maximum physical space size.

Step 510 is followed by a step 520 of receiving a command that involves an allocation requirement for allocating space to a logical object, e.g. a file. The command may be an explicit request for allocating space or for increasing the size of the file, for example: The NFS command SetAttributes that includes a size attribute with a value that is bigger than the current size of the file. The command may otherwise include an implicit requirement for space allocation, i.e.: a write request that involves writing beyond the virtual space currently allocated for the file. Following are examples of allocation requirement and a required size: referring back to FIG. 4b, the current physical size of the file is 1000 bytes (500+500), the available virtual space is 500 bytes (the available space in virtual allocation unit 411). Suppose the write request is for writing 700 bytes. Out of the 700 bytes, 500 virtual bytes can be provided from the current used allocation unit 411, but the rest 200 bytes requires a new virtual allocation. Thus, the write request includes an implicit allocation requirement of 200 bytes. Another example, the write request is of 100 bytes, at an offset of 1200 bytes from address zero of the file. Though the current physical size of the file is 1000 bytes, the virtual address range allocated for the file is of 0-1500, provided by allocation unit 411. The write request can be provided without any further virtual allocation, by mapping a portion of allocation unit 411, at address range 1200 to 1300, to a physical range. Yet another example: the write request is of 100 bytes but the requested offset for writing is 1700, which is out of the range of allocation unit 411. In this case, the write request imposes an allocation requirement of 300 bytes, 200 bytes are required for writing beyond the range of the current virtual space available for the file and another 100 bytes for writing from this point on.

Step 520 is followed by a step 525 of checking whether a current allocation unit used by the logical object can accommodate the additional space imposed by the command. If so, step 525 is followed by step 540. If the current allocation unit is full or cannot provide the entire space required, step 520 is followed by step 530.

Step 530 includes allocating, in the virtual address space corresponding to the filesystem, at least one virtual allocation unit including a range of contiguous virtual block addresses. Step 530 includes determining a size for allocation and selecting a virtual allocation unit having the determined size. The size is determined in accordance with the current physical size of the file, regardless of the size required with respect to the allocation requirement. The size of the selected virtual allocation unit is substantially larger than a size required. The size required with respect to the allocation requirement may be explicitly specified in the request or may be implied by the request. Suppose the size required with respect to the allocation requirement is e.g. 100 bytes and the file size is e.g. 2 M bytes. The size of allocation units allocated for files of such size is 1 M bytes, regardless of the size required (100 bytes). Prior art allocation schemes may allocate the exact size required or may round up the allocation size to a block boundary. For example: if the size required for allocation is 600 bytes and a block size used by the filesystem or by the underlying storage device is 512 bytes, the selected allocation size is 1024 instead of 600. According to the presently disclosed subject matter, the size allocated to satisfy the request is more than just rounding up the required size to a block boundary, for example: the size allocated can be a factor or even orders of magnitude larger than the size required and at least as twice the size requested.

Step 530 may include selecting a specific allocation zone from the multiple allocation zones, based on the current physical size of the logical object. The current physical size of the file may be compared to multiple size thresholds, and the size of the virtual allocation unit is selected from multiple allocation unit sizes, respectively associated with the multiple size thresholds. An allocation zone that corresponds to the requested size of the virtual allocation unit, is then selected. Step 530 may include allocating one or more allocation units from the plurality of virtual allocation units of the specific allocation zone. The default number of allocation units is one. For example: suppose that the selected allocation size is 2 MB. The allocation zone that best fits this allocation size is allocation zone 201(2) that includes 1 MB allocation units. Accordingly, the number of allocation units is selected as two.

The size of the allocation unit and/or the total allocation size (i.e. “allocation unit size” times “number of allocation units”) is proportional to the file size, i.e. the bigger the file is, the bigger is the allocation unit size (or total allocation size).

Note that the allocation is a logical allocation that ensures reservation of contiguous space from the virtual address space of the logical volume.

Step 530 is followed by step 535 of associating a start virtual address of the virtual allocation unit with an offset within an address range of the logical object (file's logical block number, LBN). Step 535 further include storing the association information in a mapping metadata structure of the file, e.g. in an Mode or a B-tree that is used for mapping file blocks into LBAs within the volume. The start virtual address of the virtual allocation unit serves as the LBA. Note that since the allocation unit maps virtual addresses, within the range of the allocation unit, into multiple physical address ranges (each range is allocated as a result of a different write request), one entry in the mapping metadata structure aggregates multiple physical address ranges, represented by the virtual allocation unit.

Step 540 is executed upon receiving subsequent write requests, related to the logical object and indicative of a write size, i.e. the size of the data to be written. A write request may involve or include the allocation requirement that is handled in step 520, in case the write request involves writing beyond the virtual space currently allocated for the file, i.e. a previously allocated virtual allocation unit is full or cannot satisfy the write request. Alternatively, the write request is separate from the allocation requirement. Step 540 includes enabling allocating, per each of the subsequent write requests, a physical block address range in the physical storage space and enabling associating the physical block address range with a respective portion of the virtual allocation unit. The size of the portion corresponds to the write size, e.g. the size of the portion may be the same as the write size or may be rounded up to the next block boundary. The allocation of the physical block addresses and their association with the portion of the virtual allocation unit may be performed by object management system 100 or may be performed by an underlying storage system, such as block control layer 103.

In case the association of the portion and the physical block addresses is performed by another entity, such as block control layer 103, the enabling of the association (performed by object management system 100) includes providing at least the start virtual address of the portion and the write size. Block control layer 103 is configured to handle a mapping data structure for associating virtual addresses and physical addresses.

Note that multiple subsequent write requests (including the write request that triggered the allocation requirement), related to the file, can be served by the same virtual allocation unit that was allocated in step 520, such that per each of the write requests, the physical block address range allocated in the physical storage space is associated with a respective portion of the virtual allocation unit. Each physical block address range is associated with a different portion of the virtual allocation unit, as illustrated in FIGS. 4a-4c. For sequential write requests, successive portions are associated with the respective physical block address range, as illustrated in FIGS. 4a and 4b, while for write requests that relates to non-sequential addresses, a non-contiguous portion, such as portion 411c, may be associated with the respective physical block address range.

FIG. 5a illustrates a method 500′ that is performed by storage system 150. Steps 510-535 of method 500′ are identical to the respective steps in method 500 of FIG. 5 and are performed by object management system 100 included in storage system 150. Method 500′ includes step 550 that is performed by block management system 120 of storage system 150. Step 550 includes allocating, upon a write request, physical block addresses in the physical storage space and associating the physical block addresses with a portion of the virtual allocation unit.

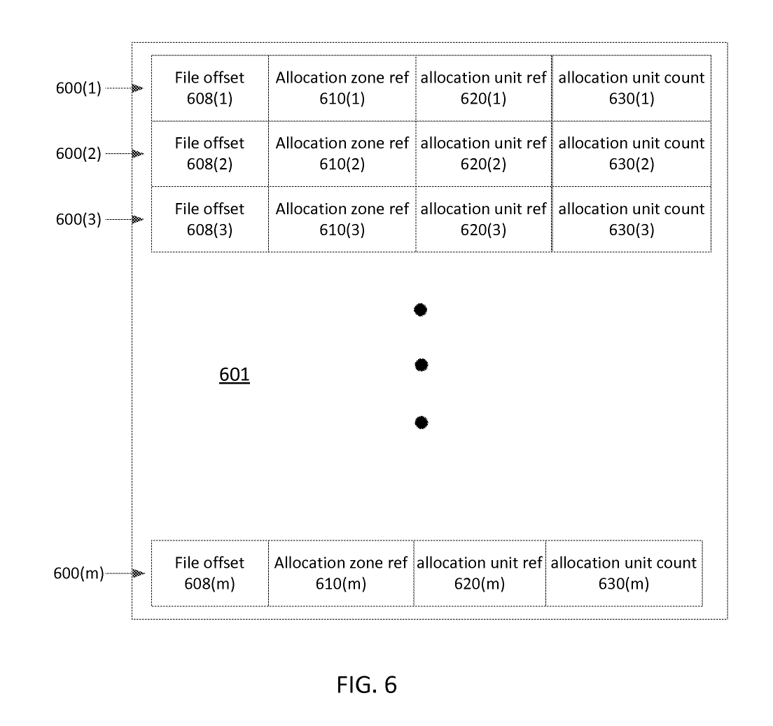

FIG. 6 is a schematic example of an extent list 601 that is part of a metadata entry (Mode) of one file. Extent list 601 includes up to m extent entries 600(1)-600(m), each extent entry 600 includes a file offset 608 (an address offset relative to the start of the file) and a reference to the volume location, also known as LBA. According to embodiments of the invention, the reference to the volume location includes identification of the virtual allocation unit associated with the file's offset, including: (i) an allocation zone reference 610, which is preferably an index, having a value 1 to n of the allocation zone, wherein n is the number of allocation zones. Suppose there are 16 allocation zones, then 4 bits can represent allocation zone reference 610. Alternatively, allocation zone reference 610 may be a pointer to the start address of the allocation zone or any other reference that uniquely identifies the allocation zone; (ii) Allocation unit reference 620, refers to the first allocation unit of this extent and may be an index, having a value 1 to k, wherein k—is the number of allocation units in the allocation zone. Note that k may vary among allocation zones, as each allocation zone may have a different number of allocation units. Allocation unit reference 620 may otherwise be an offset from the start address of the allocation zone or may be an absolute address of the allocation unit, in which case, allocation zone reference 610 can be omitted; and (iii) Allocation unit count 630 (optional) is a number of consecutive allocation units for this extent, starting at allocation unit reference 620.

Since the reference to the volume location is the reference to the virtual allocation unit and the allocation unit is substantially large for large files, the number of extent entries is reduced, as an entry is created only upon allocation of virtual allocation unit, which in turn serves multiple write requests.

The presently disclosed subject matter further contemplates a machine-readable storage device tangibly embodying a program of instructions executable by the machine for executing the method of the presently disclosed subject matter.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

It will also be understood that the system according to the presently disclosed subject matter may be a suitably programmed computer. Likewise, the presently disclosed subject matter contemplates a computer program being readable by a computer for executing the method of the presently disclosed subject matter. The presently disclosed subject matter further contemplates a machine-readable memory tangibly embodying a program of instructions executable by the machine for executing the method of the presently disclosed subject matter.

1. A method of allocating space for logical objects of a filesystem, utilizing a processor, operatively coupled to one or more physical storage devices constituting a physical storage space, the method comprising:
a. responsive to an allocation requirement, related to a logical object owned by the filesystem, allocating, by the processor, in a virtual address space corresponding to the filesystem, a virtual allocation unit, comprising a range of contiguous virtual block addresses; wherein a size of the virtual allocation unit is determined in accordance with a current physical size of the logical object; and wherein the size of the virtual allocation unit is substantially larger than a size required with respect to the allocation requirement; and
b. responsive to subsequent write requests, related to the logical object, enabling allocating, per each of the subsequent write requests, a physical block address range in the physical storage space and enabling associating the physical block address range with a respective portion of the virtual allocation unit.

2. The method of claim 1 further comprising assigning to the filesystem the virtual address space and a maximum physical space size available for use by the filesystem in the physical storage space, wherein a size of the virtual address space is substantially larger than the maximum physical space size.

3. The method of claim 1, wherein the virtual address space is associated with a logical volume assigned for the filesystem.

4. The method of claim 1 further comprising associating the virtual allocation unit with an offset within an address range of the logical object.

5. The method of claim 1 comprises comparing the current physical size of the logical object to multiple size thresholds and selecting the size of the virtual allocation unit from multiple allocation unit sizes respectively associated with the multiple size thresholds.

6. The method of claim 5, wherein values of the multiple allocation unit sizes respectively depend on the multiple size thresholds and represent a growth sequence.

7. The method of claim 1 further comprising, upon initialization of the filesystem, logically dividing the virtual address space into multiple allocation zones, respectively associated with multiple allocation unit sizes; wherein each allocation zone includes a plurality of virtual allocation units of equal size, the equal size being one of the multiple allocation unit sizes.

8. The method of claim 7, wherein the step of allocating a virtual allocation unit comprising selecting a specific allocation zone from the multiple allocation zones, in accordance with the current physical size of the logical object and allocating the virtual allocation unit from the plurality of virtual allocation units of the specific allocation zone.

9. A system for managing logical objects, the system comprising a processor operatively coupled to a memory accessible by the processor, wherein the system is operatively coupled to at least one storage device constituting a physical storage space, wherein the memory is configured to handle a virtual address space comprising virtual block addresses, and wherein the processor is configured to:
responsive to an allocation requirement, related to a logical object owned by a filesystem, allocate, in a virtual address space corresponding to the filesystem, a virtual allocation unit, comprising a range of contiguous virtual block addresses; wherein a size of the virtual allocation unit is determined in accordance with a current physical size of the logical object; and wherein the size of the virtual allocation unit is substantially larger than a size required with respect to the allocation requirement; and
responsive to subsequent write requests, related to the logical object, enable allocation, per each of the subsequent write requests, a physical block address range in the physical storage space and enable association of the physical block addresses with a respective portion of the virtual allocation unit.

10. The system of claim 9 wherein the processor is configured to assign to the filesystem the virtual address space and a maximum physical space size available for use by the filesystem in the physical storage space, wherein a size of the virtual address space is substantially larger than the maximum physical space size.

11. The system of claim 9, wherein the virtual address space is associated with a logical volume assigned for the filesystem.

12. The system of claim 9, wherein the processor is configured to associate the virtual allocation unit with an offset within an address range of the logical object.

13. The system of claim 9, wherein the processor is configured to determine the size of the virtual allocation unit by comparing the current physical size of the logical object to multiple size thresholds and selecting the size of the virtual allocation unit from multiple allocation unit sizes respectively associated with the multiple size thresholds.

14. The system of claim 9, wherein the processor is configured, upon initialization of the filesystem, to logically divide the virtual address space to multiple allocation zones, respectively associated with multiple allocation unit sizes; wherein each allocation zone includes a plurality of virtual allocation units of equal size, the equal size being one of the multiple allocation unit sizes.

15. The system of claim 14, wherein the processor is configured to select a specific allocation zone from the multiple allocation zones, in accordance with the current physical size of the logical object and allocate the virtual allocation unit from the plurality of virtual allocation units of the allocation zone.

16. A program storage device readable by machine, that stores program instructions for:
a. responsive to an allocation requirement, related to a logical object owned by a filesystem, allocating, by the processor, in a virtual address space corresponding to the filesystem, a virtual allocation unit, comprising a range of contiguous virtual block addresses; wherein a size of the virtual allocation unit is determined in accordance with a current physical size of the logical object; and wherein the size of the virtual allocation unit is substantially larger than a size required with respect to the allocation requirement; and
b. responsive to subsequent write requests, related to the logical object, enabling allocating, per each of the subsequent write requests, a physical block address range in the physical storage space and enabling associating the physical block address range with a respective portion of the virtual allocation unit.

17. The program storage device of claim 16 further stores program instructions for: associating the virtual allocation unit with an offset within an address range of the logical object.

18. The program storage device of claim 16 further stores program instructions for: comparing the current physical size of the logical object to multiple size thresholds and selecting the size of the virtual allocation unit from multiple allocation unit sizes respectively associated with the multiple size thresholds.

19. The program storage device of claim 16 further stores program instructions for: upon initialization of the filesystem, logically dividing the virtual address space into multiple allocation zones, respectively associated with multiple allocation unit sizes; wherein each allocation zone includes a plurality of virtual allocation units of equal size, the equal size being one of the multiple allocation unit sizes.

20. The program storage device of claim 19 further stores program instructions for: selecting a specific allocation zone from the multiple allocation zones, in accordance with the current physical size of the logical object and allocating the virtual allocation unit from the plurality of virtual allocation units of the specific allocation zone.

21. A storage system for managing logical objects, the storage system comprising an object management system and a block management system, wherein the storage system is coupled to at least one storage device constituting a physical storage space;
wherein, responsive to an allocation requirement related to a logical object owned by a filesystem, the object management system is configured to allocate, in a virtual address space corresponding to the filesystem, a virtual allocation unit, comprising a range of contiguous virtual block addresses; wherein a size of the virtual allocation unit is determined in accordance with a current physical size of the logical object; and wherein the size of the virtual allocation unit is substantially larger than a size required with respect to the allocation requirement; and
wherein, responsive to subsequent write requests related to the logical object, the block management system is configured to allocate, per each of the subsequent write requests, a physical block address range in the physical storage space and associate the physical block addresses with a respective portion of the virtual allocation unit.
